(19) United States
(12) Patent Application Publication
(10) Pub. No.: US 2018/0157279 A1
(43) Pub. Date: Jun. 7, 2018

(54) Electronic Fluid Metering Valve

(71) Applicant: RAM Manufacturing Company, Inc., St. George, UT (US)

(72) Inventors: Ray Ganowsky, St. George, UT (US); Tom P. Thompson, St. George, UT (US); Douglas Scott Petty, Hurricane, UT (US); Joshua Bruce Marriott, St. George, UT (US)

(21) Appl. No.: 15/830,937

(22) Filed: Dec. 4, 2017

Related U.S. Application Data
(60) Provisional application No. 62/429,543, filed on Dec. 2, 2016.

(51) Int. Cl. G05D 7/06; F16K 31/06; F16K 1/12; F16K 37/00; H01F 7/06

(52) U.S. Cl. CPC G05D 7/0635; F16K 31/0675; H01F 7/06; F16K 37/005; F16K 1/12

(57) ABSTRACT

An electronic fluid metering valve is provided, which may include a valve body and a proportional solenoid. The fluid metering valve has an inlet and an outlet, with a needle disposed between the inlet and the outlet to control the flow of fluid through the valve. An armature is disposed within the valve body and at least a first flat spring is disposed between the armature and the valve body. A second flat spring is disposed between the needle and the valve body. A method of metering fuel flow may also be provided, including the step of adjusting the current input to adjust the flow of fluid.

### PRIORITY CLAIM

This application claims priority to U.S. Provisional Application No. 62/429,543 filed on Dec. 2, 2016 entitled “Electronic Fluid Metering Valve” which is incorporated herein by reference in its entirety.

### FIELD OF THE TECHNOLOGY

This disclosure is directed toward electronic fluid flow control mechanisms. Specifically, this invention is directed toward a proportional or linear solenoid valve for metering the flow of fluid as a function of input current.

### BACKGROUND OF THE TECHNOLOGY AND RELATED ART

In various applications, it is desirable to meter the flow of fluid to a device. For example, it may be desirable to provide only the amount of fuel necessary for operation of any engine to which fuel may be supplied. To increase efficiencies in operation of engines, various techniques may be employed to meter the flow of fuel. Such techniques may equally apply to the metering of any fluid for a desired application.

Traditionally, the flow of fuel is metered by means of a servo valve that is internally controlled by a small torque motor. Such systems often require a controller with a built in linear variable differential transformer (LVDT) to operate the feedback circuit through an amplifier driver card. In other applications, a non-proportional solenoid may be cycled on and off at a high frequency for a selected number of times to provide the desired amount of fuel. However, such known practices may require multiple components or may cause excessive wear, both of which lead to high costs and potentially low long-term reliability for the desired fluid metering.

Thus, there continues to be a need for an improved electronic mechanism for metering the flow of fluid.

### BRIEF DESCRIPTION OF THE DRAWINGS

The present technology will become more fully apparent from the following description and appended claims, taken in conjunction with the accompanying drawings. Understanding that these drawings merely depict exemplary aspects of the present technology they are, therefore, not to be considered limiting of its scope. It will be readily appreciated that the components of the present technology, as generally described and illustrated in the figures herein, could be arranged and designed in a wide variety of different configurations. Nonetheless, the technology will be described and explained with additional specificity and detail through the use of the accompanying drawings in which:

FIG. 1 is an isometric view of a fluid metering valve in accordance with one aspect of the technology;

FIG. 2 is an isometric cross-sectional view of the fluid metering valve of FIG. 1, taken along line A-A.

FIG. 3 is a cross-sectional view of the fluid metering valve of FIG. 1 taken along line A-A;

FIG. 4 is a detailed view of a portion of the cross-sectional view of FIG. 3;

FIG. 5 is an exploded assembly view of the fluid metering valve of FIG. 1;

FIG. 6 is a detailed view of a portion of the exploded assembly view of FIG. 5;

FIG. 7 is a detailed cross-sectional view of another embodiment of a fluid metering valve in accordance with one aspect of the technology;

FIG. 8 is a detailed cross-sectional view of yet another embodiment of a fluid metering valve in accordance with one aspect of the technology;

FIG. 9 is a is an isometric view of another example of a fluid metering valve in accordance with one aspect of the technology;

FIG. 10 is a front view of the fluid metering valve of FIG. 9;

FIG. 11 is an isometric cross-sectional view of the fluid metering valve of FIG. 10, taken along line B-B;

FIG. 12 is a cross-sectional view of the fluid metering valve of FIG. 10, taken along line B-B;

FIG. 13 is a detailed view of a portion of the cross-sectional view of FIG. 12;

FIG. 14 is an exploded assembly view of the fluid metering valve of FIG. 9;

FIG. 15 is a detailed cross-sectional view of another embodiment of a fluid metering valve including a needle in accordance with one aspect of the technology;

FIG. 16 is a detailed cross-sectional view of another embodiment of a fluid metering valve including another needle in accordance with one aspect of the technology; and

FIG. 17 is a detailed cross-sectional view of another embodiment of a fluid metering valve including yet another needle in accordance with one aspect of the technology.

### DETAILED DESCRIPTION

The following detailed description includes reference to the accompanying drawings, which form a part hereof and in which are shown, by way of illustration, exemplary embodiments. It is believed that fluid control valves which utilize different needle arrangements or proportional movement of component parts of the valve will improve the performance of the valve. However, before the present technology is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a line” includes a plurality of such lines.

The term “fluid” used herein refers both to compressible fluids (gases, such as evaporated gasoline, etc.) and non-compressible fluids (liquids, such as gasoline, oil etc.).

In this disclosure, “comprises,” “comprising,” “containing” and “having” and the like can have the meaning ascribed to them in U.S. patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. patent law. “Consisting essentially of” or “consists essentially of” have the meaning generally ascribed to them by U.S. patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this specification it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in a fluidic or non-fluidic manner.

Objects described herein as being “adjacent to” each other may be in physical contact with each other, in close proximity to each other, or in the same general region or area as each other, as appropriate for the context in which the phrase is used.

Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of particles would either completely lack particles, or so nearly completely lack particles that the effect would be the same as if it completely lacked particles. In other words, a composition that is” substantially free of an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.8, 3, 3.1, 4, 4.6, and 5, individually.

This same principle applies to ranges reciting only one numerical value as a minimum or a maximum. Furthermore, such an interpretation should apply regardless of the breadth of the range or the characteristics being described.

As used herein, “enhanced,” “improved,” “performance-enhanced,” “upgraded,” “improvement,” and the like, when used in connection with the description of a device, component, or process, refers to a characteristic of the device, component or process that provides measurably better form, function, or outcome as compared to previously known devices or processes. This applies both to the form and function of individual components in a device or process, as well as to such devices or processes as a whole.

Reference throughout this specification to “an example” means that a particular feature, structure, or characteristic described in connection with the example is included in at least one embodiment. Thus, appearances of the phrase “in an example” in various places throughout this specification are not necessarily all referring to the same embodiment.

### Example Embodiments

It should be understood that the aspects of the technology discussed herein are contemplated for use with any type of fluid-metering valve is desired. For purposes of illustrating the various aspects of the methods and systems claimed herein, the discussion below will be primarily directed to describing exemplary embodiments directed to fluid metered valves. It should be noted, however, that the elements and principles discussed herein are applicable to other applications. It is also noted that discussion of methods and systems herein can be interchangeable with respect to specific aspects. In other words, specific discussion of one method or system (or components thereof) herein is equally applicable to other aspects as they relate to the system or method, and vice versa.

Aspects of the technology provide for a solenoid valve to meter the flow of fluid as a function of input current. It may be desirable to meter the flow of fluid to various applications to control the amount of fluid being used in the application. For example, the fluid metering valve of the technology may be used to meter the flow of fuel to an engine, such as a jet engine. Alternatively, the fluid metering valve of the technology may be used to meter the flow of any other fluid, including liquids, gases, compressible fluids and non-compressible fluids, as each may be delivered to any application that may require control and efficiency in the distribution of the fluid. According to aspects of the technology, the fluid metering valve includes a direct acting, 2-way inline valve, coupled with a solenoid having an armature, a poppet and a needle that is suspended by one or more flat springs, which may be Archimedes-type springs or flexure springs, pro traditional fluid metering mechanisms. The fluid metering valve of the present technology provides various advantages including increased reliability, reduced number of required components and reduced cost.

The fluid metering valve according to aspects of the technology comprises a proportional solenoid valve that meters flow of a fluid, wherein a moving armature is suspended by at least one flat spring. In other words, a flat spring is disposed between a valve body of the solenoid valve and the armature, such that the armature is movably suspended within the valve body without touching the valve body. In embodiments of the technology, two flat springs may be disposed between the armature and the valve body, one on each end of the armature, to stabilize the suspended armature and prevent it from touching the valve body. In this way, the valve of the present technology may be frictionless, as its moving parts, including the armature, will not touch or rub against other parts of the solenoid valve.

According to aspects of the present technology, the flow of fluid is metered by a needle or pin that is also suspended by a flat spring inside of an internal orifice. The needle may be shaped or contoured so that the area between the needle and the orifice provides the desired amount of flow. For example, the shape of the needle may be arcuate, conical, or stepped. The needle or pin may not be directly coupled to the moving armature, providing significant benefits for regulating fluid flow as a function of applied solenoid current. When the valve is fully closed the fluid will be sealed by a poppet, or the flow of fluid will be limited, which is coupled to the moving armature, at an outlet orifice to create a 0 cc/min leakage condition.

The moving armature of the fluid metering valve may be a ring with small converging conical angles on the outside and the inside diameters. A machined bobbin assembly, or bobbin, having two parallel conical angles matching the angles of the armature may be disposed adjacent the armature in the solenoid valve assembly. When current is applied to a coil surrounding the bobbin, the alignment of the angled faces of the bobbin and the armature create an electromagnetic force that is nearly independent of the linear distance between the bobbin and the moving armature, providing that this distance is small relative to the overall diameter of the solenoid. This electromagnetic force will increase as the amount of current through the coil increases.

A certain electrical current applied to the coil may create enough electromagnetic force between the moving armature and the bobbin to overcome the pressure force applied to the poppet. This electromagnetic force may cause the moving armature and poppet assembly to move linearly and allow a small amount of flow through the outlet orifice. The flat spring that suspends the needle may be set to have a pre-load such that the combined forces of both it and the one or more flat springs suspending the armature is greater than the electromagnetic force required to open the valve. This pre-load condition may cause the armature and poppet assembly to become static at the point where the poppet contacts the needle. The summation of forces of the flat springs and the opposing electromagnetic force produced by the solenoid will create a nearly proportional relationship between the amount of current applied to the coil and the linear movement of the needle. The linear movement of the needle in relation to the internal orifice directly controls the amount of fluid flow through the valve. Because the moving armature and the needle of the fluid metering valve are suspended in the valve by flat springs, or in other words have flat springs disposed between them and the valve body, the hysteresis of the valve will be much lower than a linear solenoid that do not use flat springs where the armature would be guided inside of a bore. The valve will also perform very well in vibration as the needle and the armature will be further insulated from vibration by the flat springs as compared to solenoid designs that do not use flat springs.

The valve of the present invention will provide consistency in the relationship between the amount of current applied and the linear movement of the needle. The geometry of the needle can be designed to produce any proportional flow desired based on the linear displacement in the axial direction of the needle. Because the moving armature is not coupled directly to the suspended needle, the metered flow will not be significantly affected by any small misalignments between the moving armature and the metering orifice or by any small rotations of the moving armature due to an electromagnetic torque created by small misalignments of moving armature and bobbin.

The proportional solenoid valve, which may be a linear solenoid valve, does not require a pilot stage. The valve is direct acting utilizing an external flow meter and card or driver to increase or decrease the current to obtain the desired flow. The valve is also not as susceptible to contamination due to the self-cleaning characteristics of the floating needle movement. The proportional solenoid valve in accordance with aspects of the technology allows the end user more flexibility and customization by allowing them to choose the components they would like to utilize to operate the valve.

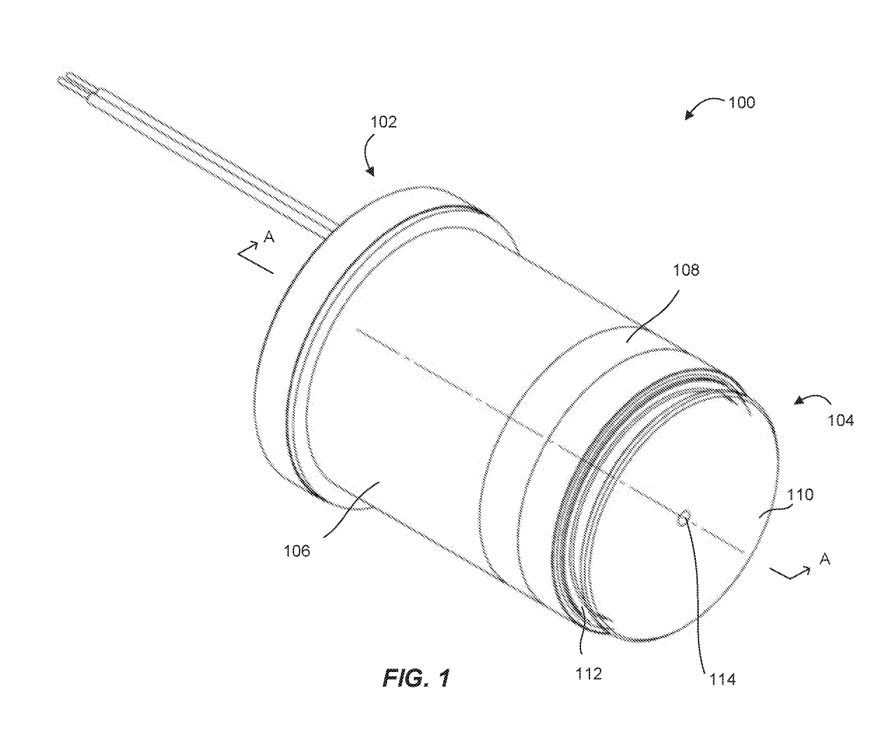

As shown in FIG. 1, a fluid metering valve 100 is provided. The fluid metering valve 100 includes a solenoid portion 102 and a valve body 104. The solenoid portion 102 includes a housing 106 and other internal components discussed below in more detail. The valve body 104 includes a valve guide 108 and a valve seat 110, the valve seat including a seal or o-ring groove 112 and an outlet or outlet port 114. The solenoid portion 102 and valve body 104 together comprise a solenoid valve, which may be a linear or proportional solenoid valve, as discussed in more detail below.

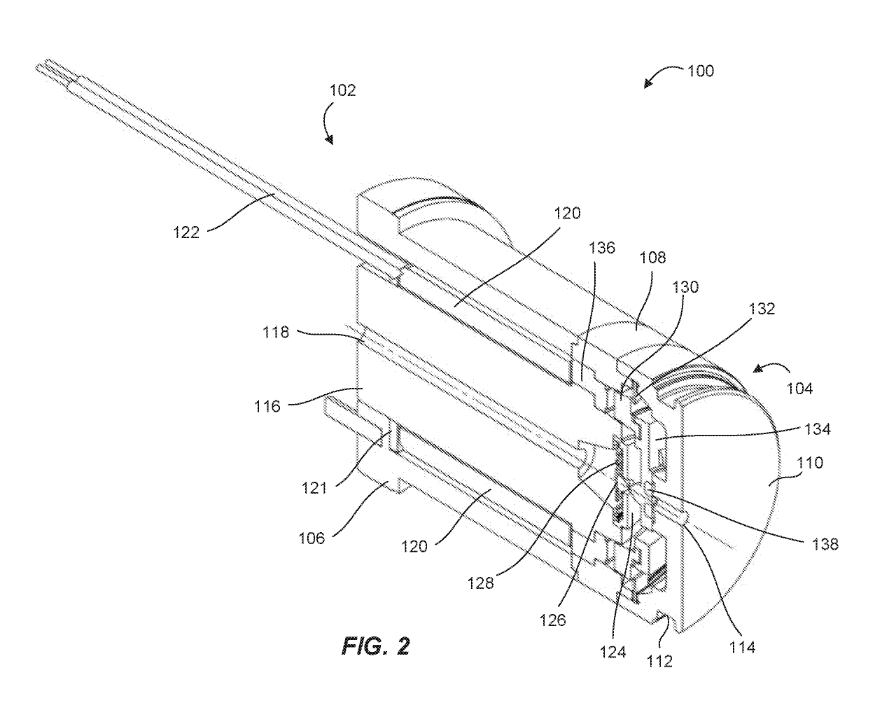

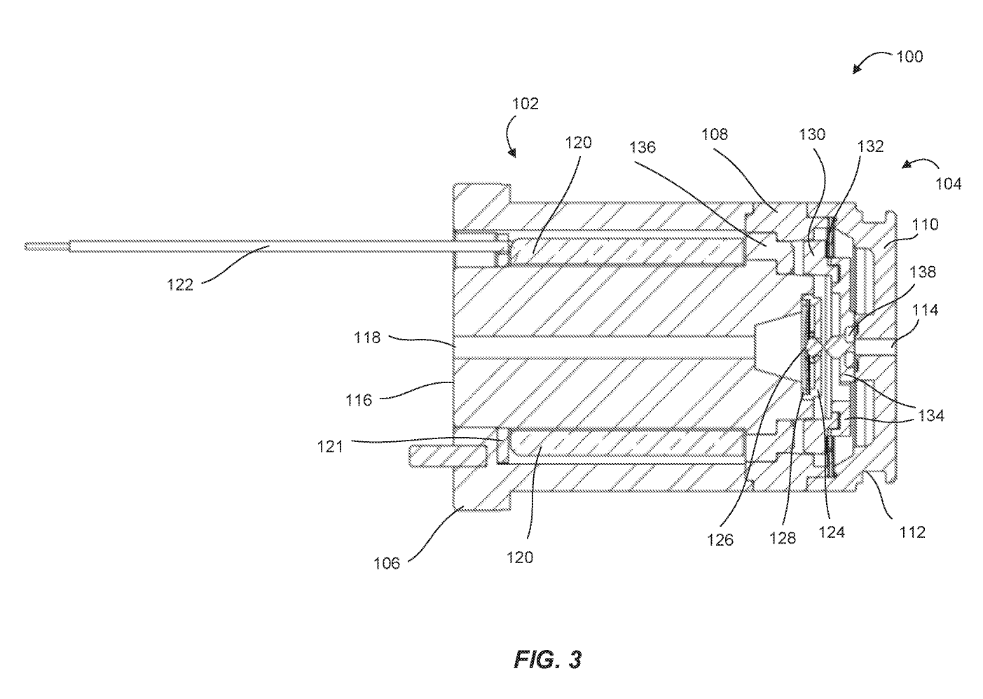

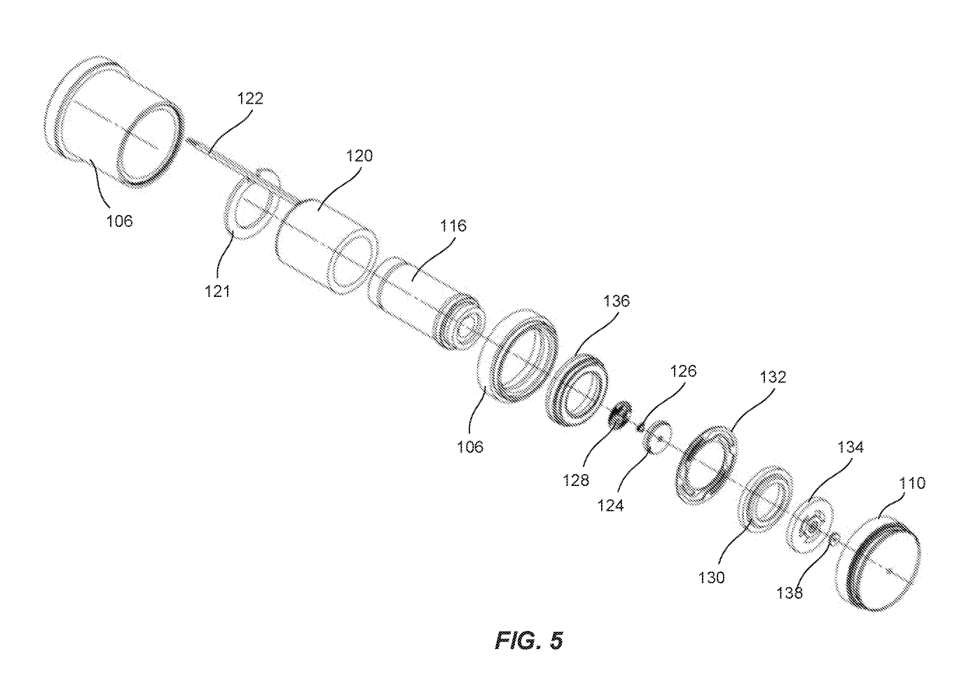

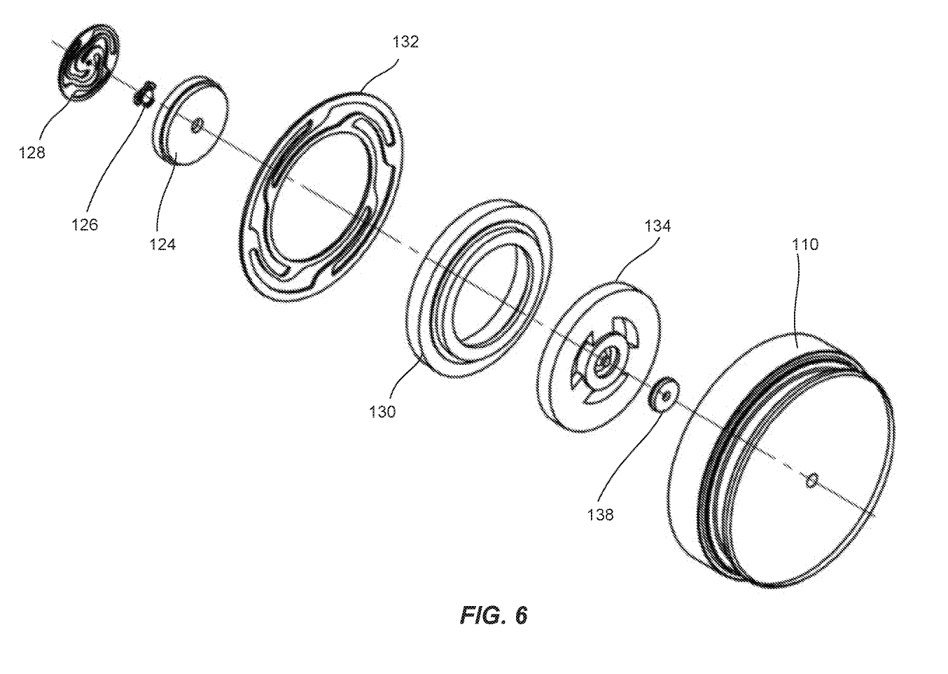

As shown in FIGS. 2-6, where like numerals represent like components, solenoid portion 102 and valve body 104 includes detailed components comprising the proportional solenoid valve. A bobbin may be disposed within housing 106 of solenoid portion 102. Bobbin 116 includes an inlet or inlet port 118. Disposed around the bobbin 116 is a coil 120, which may be a winding of any magnetic wire material. Extending from the coil 120 is a pair of lead wires 122, which supply current to the coil to operate the solenoid valve, as discussed in more detail below.

Valve body 104 further includes an armature 130, which may be a moving armature, disposed within valve seat 110. At least one flat spring, which may be Archimedes-type springs or flexure springs, or any other flat spring as known in the art. For example, flat spring 132, which may be a first flat spring, is disposed about armature 130, with an outer portion of flat spring 132 disposed within a channel or other appropriate portion of the valve body within the valve seat 110 and the valve guide 108. In this way, armature 130 is suspended from or hangs from the one or more flat springs within valve body. A poppet 134 is attached to the armature 130, thereby also being suspended by the first flat spring 132. In embodiments, the poppet 134 and the armature 130 are separate but connected bodies. In other examples of the technology, poppet 134 and armature 130 are unitary such that poppet 134 is considered a portion of armature 130. Flat spring 132 exerts a force on the armature 130 and or the poppet 134 such that it operates to limit the flow of fluid between inlet 118 and outlet 114, as described below.

Valve body 104 further includes an orifice 124 disposed proximal to the bobbin 116 and in fluidic communication with inlet 118. A needle 126, also known as a pin, is disposed between orifice 124 and bobbin 116. A second flat spring 128, which likewise may be an Archimedes-type spring, a flexure spring, or any other known flat spring, is disposed between needle 126 and valve body 104. Flat spring 128, which may be a second flat spring, and needle 126 are disposed between the orifice 124 and the bobbin 116. An inner diameter of flat spring 128 may be disposed about the needle 126. Needle 126 may be press fit into the inner diameter of flat spring 128, or may be attached or bonded to flat spring 128, such as by a tack weld. The interaction between needle 126, orifice 124 and poppet 134 and/or armature 130 of valve body 104 directly controls the flow of fluid from the inlet 118 to the outlet 114, as described below. Valve body 104 also includes a tube or plunger tube 136 disposed within the guide 108 of the valve body. The plunger tube 136 cooperates with the coil 120 and the bobbin 116 in the placement and function of the solenoid valve of the presently disclosed fluid metering valve. Valve body 104 further includes a seal 138, which may provide a fluid-tight seal, or may limit the flow of fluid, between the outlet 114 of the seat 110 and the flow of fluid through the valve body 104 from inlet 118.

The linear or proportional solenoid valve comprising fluid metering valve 100 is designed to provide a linear relationship between the amount of current supplied to coil 120 and the linear displacement of armature 130 and poppet 134, along with needle 126, which thereby control the flow of fluid. For example, in an embodiment according to aspects of the technology, needle 126 is displaced axially 0.005 inches when a current of 0.26 Amps is applied, 0.01 inches when a current of 0.35 Amps is applied, 0.015 inches when a current of 0.44 Amps is applied, 0.02 inches when a current of 0.51 Amps is applied, 0.025 inches when a current of 0.595 Amps is applied, 0.03 inches when a current of 0.65 Amps is applied, and 0.035 inches when a current of 0.74 Amps is applied. In this way, the relationship between the axial displacement of the needle and the current input may be linear.

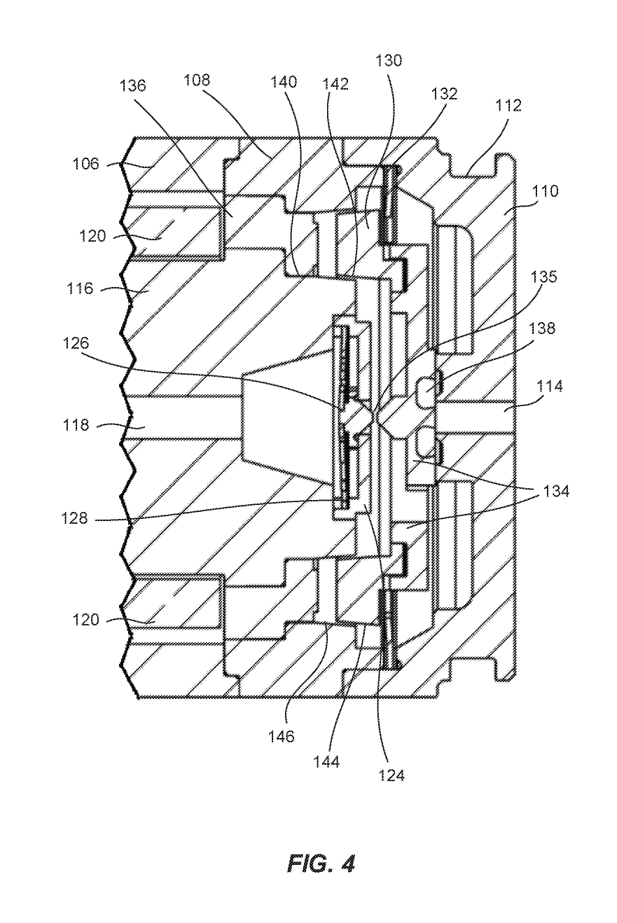

As shown specifically in FIG. 4, the bobbin 116 has a bobbin angled face 140 and the armature has an inside armature angled face 142 and an outside armature angled face 144. Guide 108 has a guide angled face 146. Angled faces 140 and 142 may be considered converging angles, as may angled faces 144 and 146. As a current is applied to coil 120 through lead wires 122, the alignment of the bobbin angled face 140 and the inside armature angled face 142, and also the alignment of the guide angled face 146 and the outside armature angled face 144, create an electromagnetic force, which increases as the amount of current applied to the coil increases. When sufficient electromagnetic force is created, the armature 130, along with the poppet 134, will be displaced linearly, moving the poppet 134 from its sealed position at outlet 114. The relationship between the needle 126 and the orifice 124 allows a small amount of flow through the orifice 124 at all times, which small amount of flow may create a pressure against the poppet 134 in its sealed or closed position. When the solenoid is de-energized, or when a current is not applied to coil 120, a gap 135 are disposed between needle 126 and poppet 134. When the armature 130 and poppet 134 are initially displaced, the poppet 134 will release from its sealed or closed position and the fluid will begin to flow through outlet 114 even though the poppet 134 may not yet have contacted the needle 126. As additional current is applied to the coil 120, the poppet 134 contacts the needle 126, moving it further from orifice 124 to allow greater flow from the inlet 118 to the outlet 114 through the orifice 124. As the solenoid 102 produces greater electromagnetic force caused by an increase in the applied current, the needle 126 is displaced further as a function of the amount of current applied, causing the flow of fluid through the valve 100 to be directly a function of the amount of current applied to the coil 120.

For example, the displacement of the needle 126 may have a nearly proportional or nearly linear relationship to the amount of current applied to the solenoid 102, or in other words to the coil 120. In an embodiment, the displacement of the needle may be proportional or linear through a certain range of current input, while variations, whether slight or great, may exist outside of the specific range of current input. The amount of fluid that flows through the valve 100 may depend on the geometry of the needle 126. For example, the needle 126 may be conical, such that as the needle 126 is displaced further away from orifice 124, the flow of fluid through orifice 124 increases exponentially. In such an example, the displacement of the needle 126 may have a linear relationship to the amount of current applied, while the flow of fluid through the orifice 124, and thus through valve 100, may be other than linear, depending on the geometry of needle 126 and orifice 124. For example, the flow of fluid through orifice 124 may be exponentially related to the amount of current applied to the solenoid, or to the coil 120 of the solenoid 102. In general, both the displacement of the needle 126 and the flow of fluid through the valve may be a function of, or in other words vary according to the value of, the input current.

The components of electronic fluid metering valve 100 may generally be formed of any material appropriate for a designated application. For example, the individual components of solenoid 102 and valve body 104 may be formed from any suitable metal, and particularly from magnetic steel such as stainless steel. In an embodiment, the components of solenoid 102 and valve body 104 may be formed from an aerospace grade stainless steel, or from a common stainless steel, as required by specific application.

The solenoid valves of the technology may be specifically designed to meet any required specifications, including size requirements, flow rate requirements, fluid pressure and temperature requirements, power supply requirements, and environmental requirements such as vibration and temperature to be experienced by the solenoid valve. In other words, the size, shape and materials of the components of the solenoid valve of the technology may be modified in any way necessary to meet any given requirement, all while maintaining the advantages of the proportional linear fluid metering valve disclosed herein.

In general, the design of the present solenoid valve allows for a high fluid pressure to size ratio. For example, a solenoid valve having an outer diameter of one inch may be designed to withstand a relatively high fluid pressure of the flow of fluid through the valve of at least 500 psi. In embodiments, the solenoid valves of the present invention may be designed to withstand maximum pressures of at least 1000 psi while maintaining a one inch outer diameter, and in other embodiments up to 1500 psi. In other embodiments, the diameter of the fluid metering valve may be one inch while the valve may be designed to function properly with a constant pressure of fluid flow through the valve of at least 100 psi, 200 psi, 300 psi, 350 psi, 400 psi, 450 psi, 500 psi, 550 psi, 660 psi, 650 psi, 700 psi, 750 psi, 800 psi, 850 psi, 900 psi, 950 psi or 100 psi. According to other aspects of the technology, a fluid metering valve may have an outer diameter of less than one inch, or of one-half inch, or of more than one inch, or of one and a half inches, or of two inches, or larger. The outer diameter may be designed to meet both the physical requirements of any application, as well as the flow rate and pressure requirements of any application. In general, a larger diameter valve may withstand higher pressures of the flow of fluid through the valve. A fluid metering valve of the present invention may be designed to withstand a maximum pressure of fluid flow through the valve of anywhere between less than 10 psi and 10,000 psi, or more in aspects of the present technology.

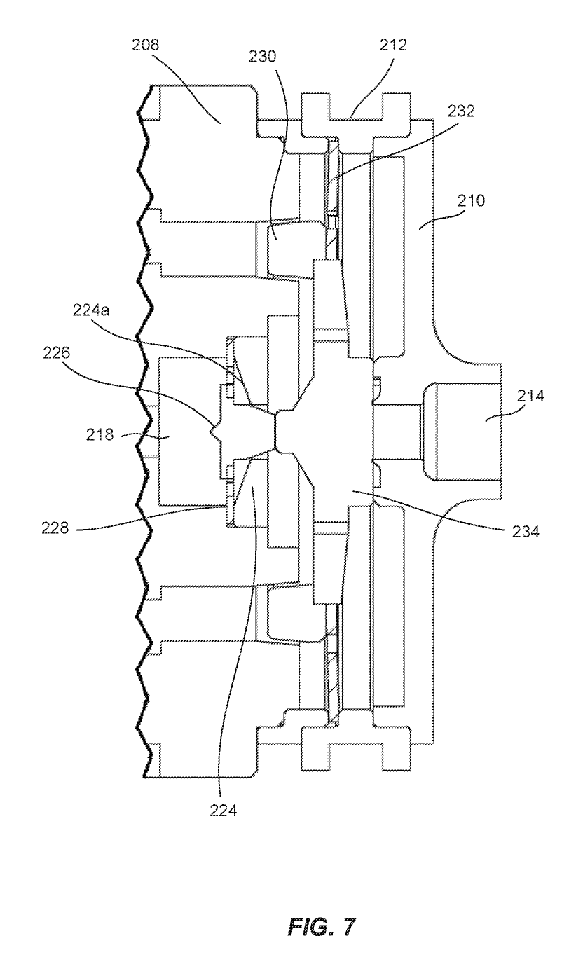

FIG. 7 depicts another example of a portion of a fluid metering valve according to the technology, where like reference numerals represent like components from previous embodiments of the fluid metering valve of the technology. Specifically, as with other embodiments disclosed herein, the valve includes a valve guide 208 and a valve seat 210, with an armature 230 suspended from a first flat spring 232. A poppet 234 is attached to the armature 230. The poppet 234 may be configured and dimensioned to provide a seal limiting flow of fluid from an inlet 218 to an outlet 214. Furthermore, an orifice 224 is disposed proximal to the inlet 218 and within the flow of fluid from inlet 218 to outlet 214. Orifice 224 may include a shape or geometry that may interact with needle 226 to provide an area through which fluid may flow. For example, orifice 224 may include a chamfer or angled surface 224a. A needle or pin 226 is suspended from a second flat spring 228 such that needle 226 interacts with orifice 224 to control the amount of fluid that may flow from the inlet 218 to the outlet 214 when the poppet 234 is displaced from its sealed position by the electromagnetic force. This fluid metering valve may function as described above with reference to valve 100, with the flow of fluid proportionally or linearly related to the amount of current applied to the solenoid valve.

Needle 226 and its interface with orifice 224 differ from other embodiments of the technology in its shape and interface with the orifice. For example, needle 226 has a larger diameter than needle 126, and is also longer with a more gradual slope. As described herein, the flow of fluid from inlet 218 to outlet 214 is controlled by the space or opening created between needle 226 and orifice 224. In an embodiment, when the solenoid of the solenoid valve is de-energized, at rest, or a current is not applied to the solenoid, needle 226 may allow for a small amount of flow through orifice 224. As needle 226 is displaced axially due to the axial displacement of armature 230 and poppet 234 when the solenoid is energized, the flow through orifice 224 may very gradually increase due to the sloped nature of needle 226. Any geometry or slope of needle 226 may be chosen to provide the desired relationship between current input that results in axial displacement of needle 226 and the amount of fluid flow through orifice 224. The shape of the needle 226 provides a flow of fluid that may be proportional to an amount of current applied to the electromagnetic solenoid.

The area between orifice 224 and needle 226 may control the amount of fluid that passes through the fuel metering valve of the present technology. For example, as needle 226 displaces in an axial direction, the area between needle 226 and orifice 224 may increase leading to the flow of fluid to increase. This may be known as the needle flow area. In aspects of the technology, the relationship between the needle flow area and the axial needle displacement may be linear or nearly linear. For example, when the needle is at rest, or with 0 inches of needle movement, the needle flow area may be 0.00019 square inches, which may be an initial cracking to allow fluid leakage as described herein. At 0.005 inches of needle displacement, the needle flow area may be 0.00125 square inches. At 0.01 inches of needle displacement, the needle flow area may be 0.002 square inches. At 0.015 inches of needle displacement, the needle flow area may be 0.0275 inches. In an embodiment, the maximum needle displacement may be 0.025 inches, and may result in a needle flow area of 0.0041 square inches. The needle and the orifice may be designed to interact in any way that will achieve the desired needle flow area. For example, as explained herein in more detail, the orifice may be flat and the needle may be arcuate, conical or stepped.

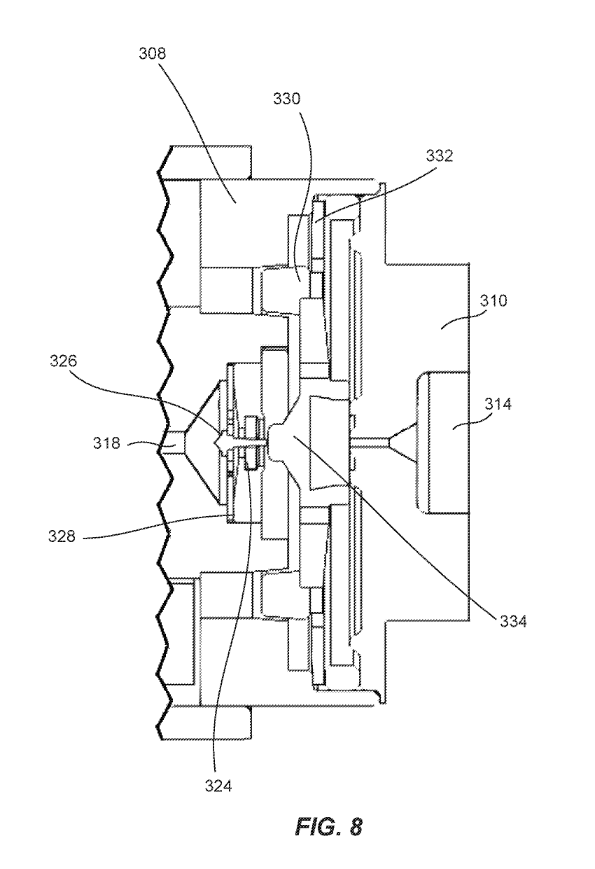

FIG. 8 depicts yet another example of a portion of a fluid metering valve according to the technology. The valve includes a valve guide 308 and a valve seat 310, with an armature 330 suspended from a first flat spring 332. A poppet 334 is attached to the armature 330. The poppet 334 may be configured and dimensioned to provide a seal limiting flow of fluid from an inlet 318 to an outlet 314. Furthermore, an orifice 324 is disposed proximal to the inlet 318 and within the flow of fluid from inlet 318 to outlet 314. A needle or pin 326 is suspended from a second flat spring 328 such that needle 326 interacts with orifice 324 to control the amount of fluid that may flow from the inlet 318 to the outlet 314 when the poppet 334 is displaced from its sealed position by the electromagnetic force. This fluid metering valve may function as described above with reference to valve 100, with the flow of fluid proportionally or linearly related to the amount of current applied to the solenoid valve. Compared to needle 126 and needle 226 of previous examples, needle 326 may have a substantially smaller diameter and may be substantially longer with a very gradual slope. As will be understood from the technology, the shape and contour of needle 326 and its interaction with orifice 324 will control the amount of fluid that flows from inlet 318 to outlet 314 based on the displacement of needle 326 caused by energizing the solenoid.

Those of ordinary skill in the art will understand that any configuration of a needle and an orifice can be employed to obtain the advantages of the presently disclosed proportional fluid metering solenoid valve. Specifically, the linear proportionality of displacement of the needle based on the amount of current input to the solenoid provides endless possibilities for desired relationships between fluid flow and current input.

In an embodiment of the present invention, a solenoid valve may be coupled with a controller to meter the current and voltage provided to the solenoid valve. A constant current and/or voltage may be applied to the solenoid valve of the present invention and may be maintained to obtain the desired flow rate. In other embodiments, a controller may be used to provide pulses of current or voltage that are controlled to provide a constant average current or voltage to the solenoid. This may be known as pulse modulation, and may provide a voltage or current that is cycled on and off at such a high frequency that the solenoid valve is not cycled from open to close, but rather maintains a constant open position. This pulse modulation results in the same function and output of the solenoid as when a constant voltage is supplied, with the significant advantages of reducing power consumption and reducing heat that results from constant power supply. In an embodiment, the appropriate average current or voltage may be applied to a solenoid valve to keep the needle of the valve floating or maintaining the desired position that will result in the desired flow.

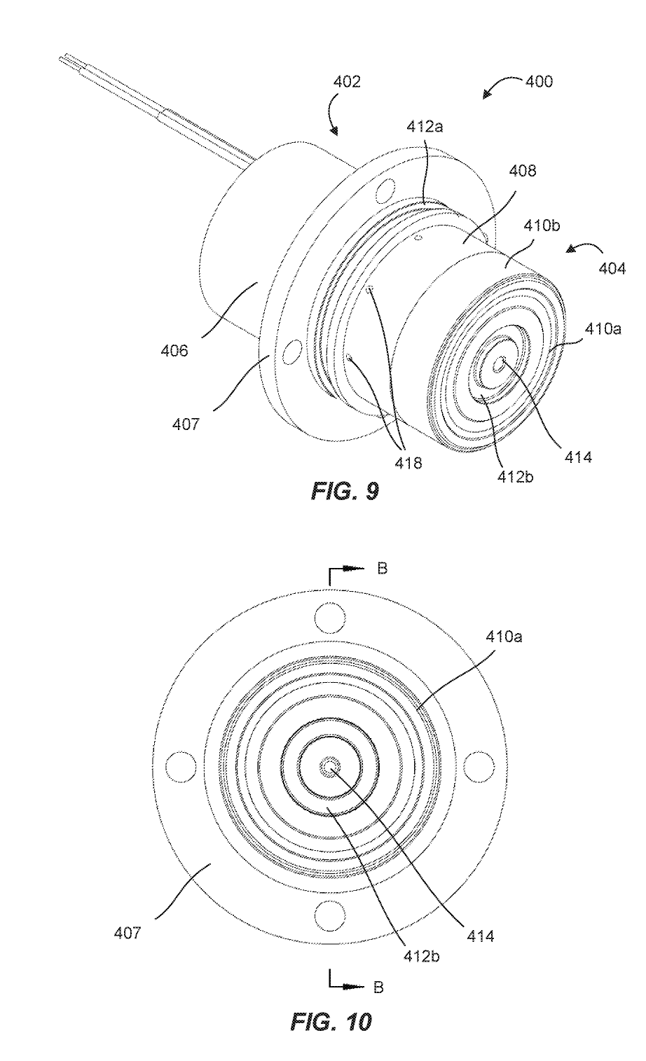

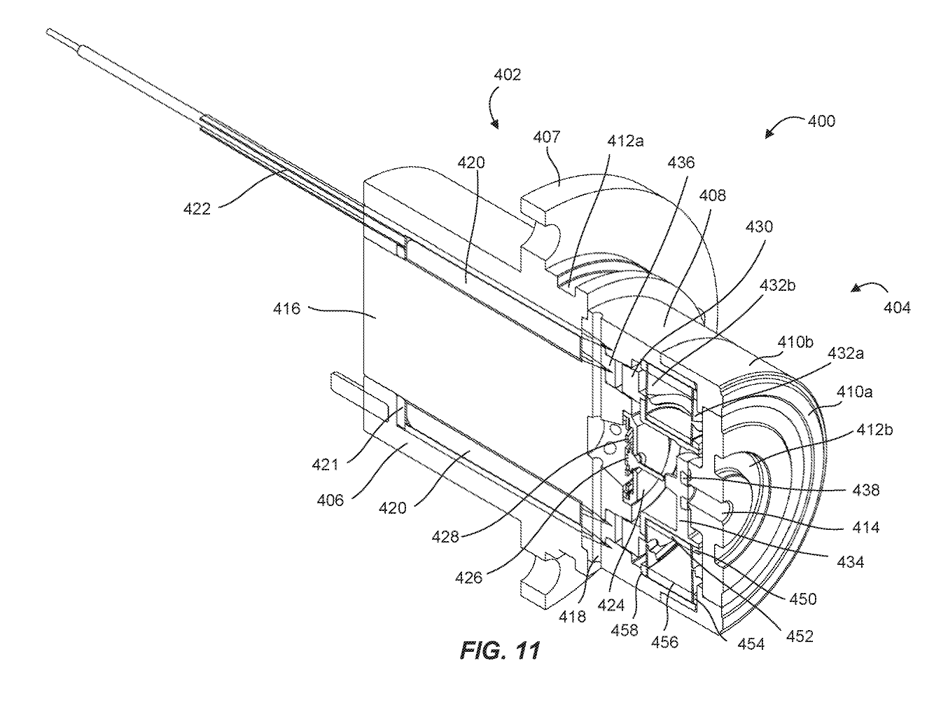

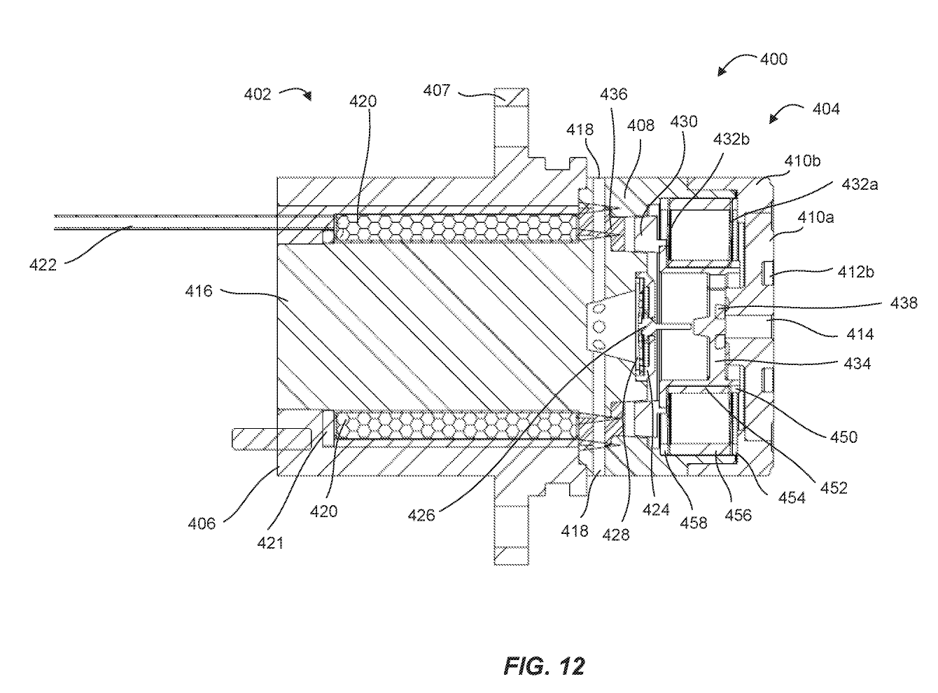

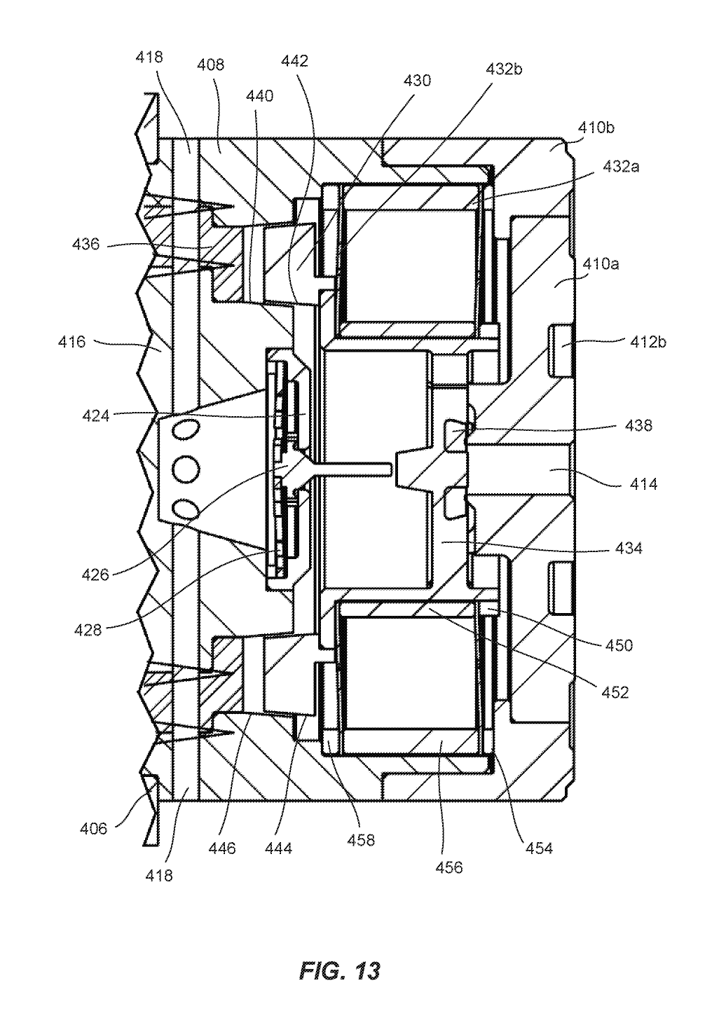

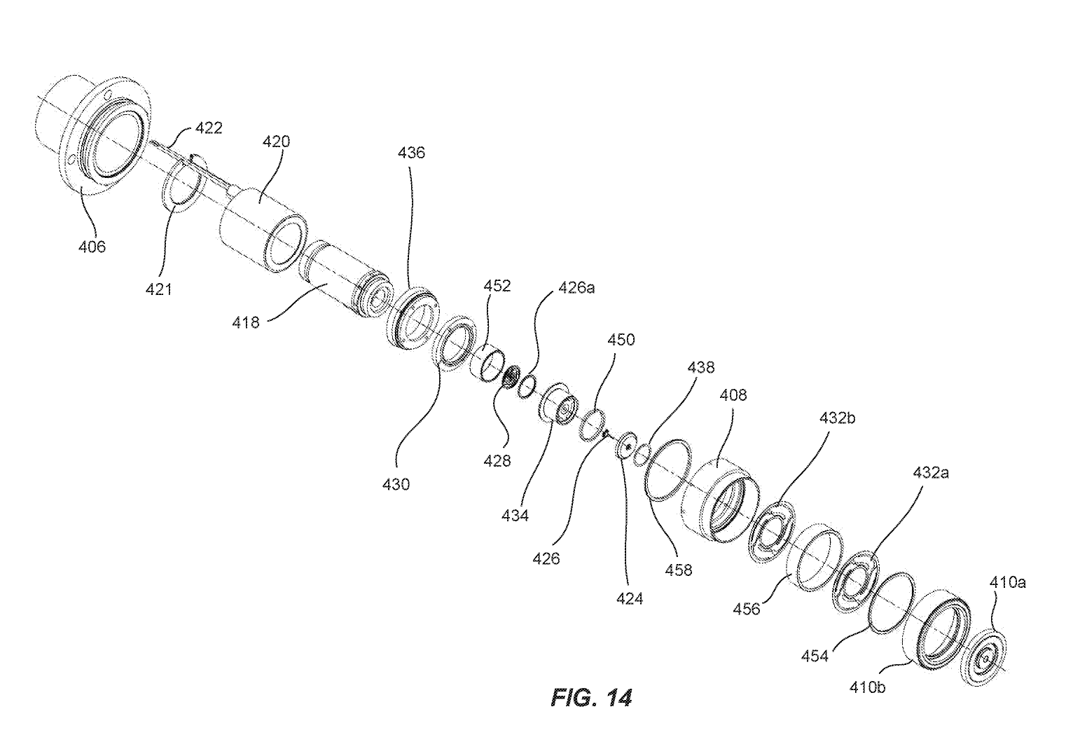

FIGS. 9-14 depict another example of a fluid metering valve 400 of the present invention, where like numerals represent like components. Fluid metering valve 400 includes solenoid portion 402 and valve body 404, each of which include detailed components comprising the proportional solenoid valve. A bobbin is disposed within housing 406 of solenoid portion 402. Disposed around the bobbin 416 is a coil 420, which may be a winding of any magnetic wire material. Extending from the coil 420 is a pair of lead wires 422, which supply current to the coil to operate the solenoid valve, as discussed in more detail below.

Bobbin 416 may include an inlet or inlet port 418. In contrast to fluid metering valve 100 of FIGS. 2-6 where inlet port 118 travels through the middle of bobbin 116 from the end of the solenoid valve opposite the valve body, fluid may be delivered to the valve through an inlet 418 or multiple inlets situated around the perimeter of the valve body. For example, multiple inlets 418 may be situated around the perimeter of the valve through a guide portion 408 or any other portion of the valve body. As will be evident to those of ordinary skill, inlet 418 may take various forms and be disposed in various positions consistent with the technology.

Valve body 404 of fluid metering valve 400 further includes an armature 430, which may be a moving armature, disposed within valve seat 410. Valve seat 410 may be a two-part valve seat which may comprise a valve seat cap 410a and a valve seat ring 410b. A poppet 434 is attached to armature 430. Armature 430 and poppet 434 may be a unitary body in aspects of the technology such that poppet 434 may be referred to as armature 430. Armature 430 and poppet 434 may be suspended from one or more flat springs 432, which may be Archimedes-type springs or flexure springs, as described herein. For example, a first flat spring 432a and a third flat spring 423b are disposed on either end of armature 430. First flat spring 432a is disposed between a front inside spacer 450 and a middle inside spacer 452 on an inside of first flat spring 432a. First flat spring 432a is also disposed between a front outside spacer 454 and a middle outside spacer 456 on an outside of first flat spring 432a. Similarly, third flat spring 432b is disposed between middle inside spacer 452 and the poppet 434 on an inside surface, while second flat spring 432b is be disposed between middle outside spacer 456 and a back outside spacer 458 on an outside surface. In aspects of the technology, first and third flat springs may be pinched or squeezed by spacers. One or more of the spacers may be attached to a portion of the valve body, such as the valve body, to secure the spacers in place as they hold the springs in place. For example, front outside spacer 454 may be tack welded to the valve body, or to valve guide 410b. In this way, first and third flat springs 432a, 432b may be connect or attach armature 430 and poppet 434 to the valve portion 402 of fluid metering valve 400.

Still with reference to FIGS. 9-14, fluid metering valve 400 may include an orifice 424 disposed proximal to the bobbin 416 and in fluidic communication with inlet 418. A needle 426, also known as a pin, is suspended from a second flat spring 428, the needle 426 and second flat spring 428 both disposed between the orifice 424 and the bobbin 416. In an embodiment, a shim 426a for needle 426 may also be disposed between orifice 424 and bobbin 416. Shim 436a provides a pre-tension to flat spring 428. The pre-tension on flat spring 428 may bias needle 426 toward orifice 424. The interaction between needle 426, orifice 424 and poppet 434 of valve body 404 directly controls the flow of fluid from the inlet 418 to the outlet 414, as described herein. Valve body 404 also includes a tube or plunger tube 436 disposed within the guide 408 of the valve body. The plunger tube 436 cooperates with the coil 420 and the bobbin 416 in the placement and function of the solenoid valve of the presently disclosed fluid metering valve. Valve body 404 further includes a seal 438, which provides a fluid-tight seal between the outlet 414 of the seat 410 and the flow of fluid through the valve body 404 from inlet 418. Fluid metering valve 400 also includes one or more o-ring grooves, which may be a back o-ring groove 412a and a front o-ring groove 412b. O-ring grooves 412a, 412b seal inlet 418 from 414, and may be disposed in any configuration suitable for the desired application of solenoid valve 400.

The one or more flat springs disposed in connection with armature 430, such as first and second flat springs 432a, 432b, may exert a force on the poppet 434 such that it operates to seal the flow of fluid between inlet 418 and outlet 414, as described herein. Armature 430 and poppet 434 will be displaced in an axial direction when current is applied to coil 420 of solenoid valve 400. Bobbin 416 has a bobbin angled face 440 and the armature has an inside armature angled face 442 and an outside armature angled face 444. Guide 408 has a guide angled face 446. As a current is applied to coil 420 through lead wires 422, the alignment of the bobbin angled face 440 and the inside armature angled face 442, and also the alignment of the guide angled face 446 and the outside armature angled face 444, create creates an electromagnetic force, which increases as the amount of current applied to the coil increases. In some embodiments, the electromagnetic force may cause armature 430 to contact bobbin 416 or guide 408. For example, the force may cause outside armature angled face 444 to contact guide angled face 446 or alternatively cause inside armature angled face 442 to contact bobbin angled face 440. Two flat springs, such as flat springs 432a, 432b, on each end of armature 430 may stabilize armature 430 such that it will not make contact with any surface of valve 400. In an embodiment, valve 400 is a frictionless valve where its moving parts are suspended by flat springs and thus do not contact or rub against other components of valve 400.

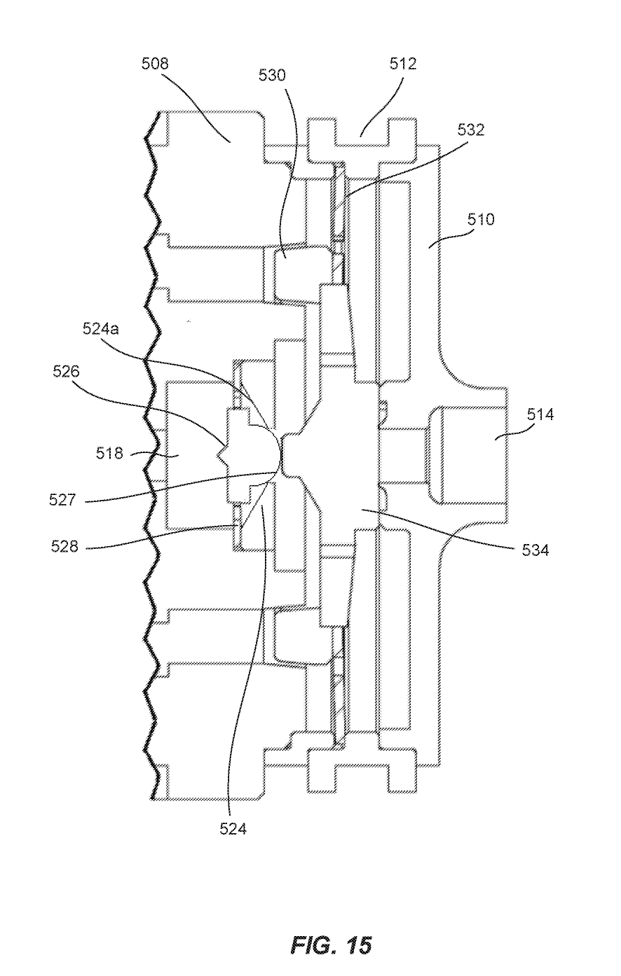

FIG. 15 depicts another example of a portion of a fluid metering valve according to the technology, where like reference numerals represent like components from previous embodiments of the fluid metering valve of the technology. Specifically, as with other embodiments disclosed herein, the valve includes a valve guide 508 and a valve seat 510, with an armature 530 suspended from a first flat spring 532. A poppet 534 is attached to the armature 530. The poppet 534 may be configured and dimensioned to provide a seal limiting the flow of fluid from an inlet 518 to an outlet 514. Furthermore, an orifice 524 is disposed proximal to the inlet 518 and within the flow of fluid from inlet 518 to outlet 514. Orifice 524 may include a shape or geometry that may interact with needle 526 to provide an area through which fluid may flow. For example, orifice 524 may include a chamfer or angled surface 524a. A needle or pin 526 is suspended from a second flat spring 528 such that needle 526 interacts with orifice 524 to control the amount of fluid that may flow from the inlet 518 to the outlet 514 when the poppet 534 is displaced from its sealed position by the electromagnetic force. This fluid metering valve may function as described above with reference to valve 100, with the flow of fluid proportionally or linearly related to the amount of current applied to the solenoid valve.

Needle 526 and its interface with orifice 524 differ from other embodiments of the technology in its shape and interface with the orifice. For example, needle 526 is spherical, or has a spherical surface 527 that interacts with orifice 524.

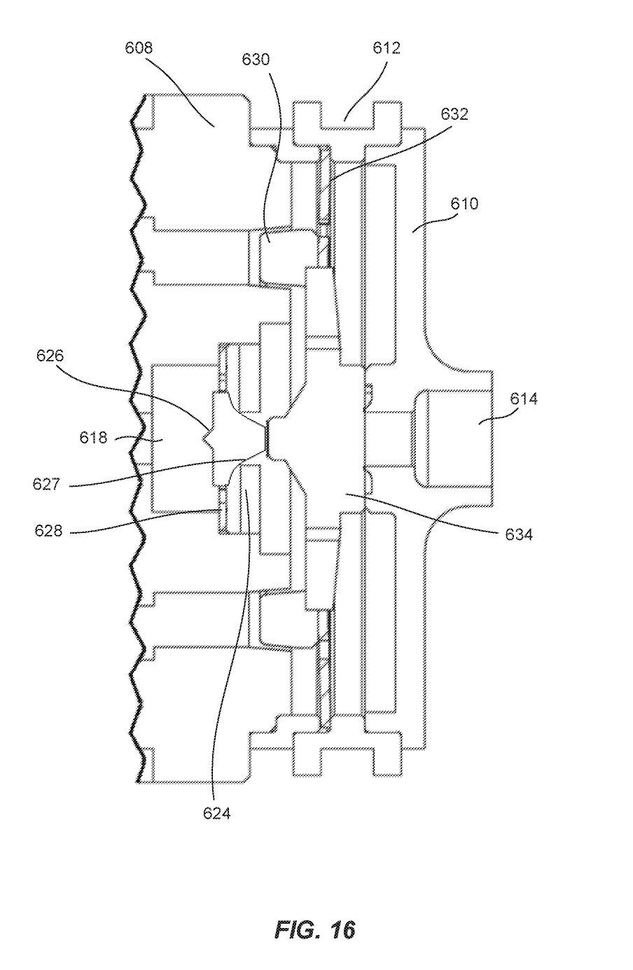

FIG. 16 depicts another example of a portion of a fluid metering valve according to the technology, where like reference numerals represent like components from previous embodiments of the fluid metering valve of the technology. Specifically, as with other embodiments disclosed herein, the valve includes a valve guide 608 and a valve seat 610, with an armature 630 suspended from a first flat spring 632. A poppet 634 is attached to the armature 630. The poppet 634 may be configured and dimensioned to provide a seal limiting the flow of fluid from an inlet 618 to an outlet 614. Furthermore, an orifice 624 is disposed proximal to the inlet 618 and within the flow of fluid from inlet 618 to outlet 614. Orifice 624 may include a shape or geometry that may interact with needle 626 to provide an area through which fluid may flow. For example, orifice 624 may include a chamfer or angled surface 624a. A needle or pin 626 is suspended from a second flat spring 628 such that needle 626 interacts with orifice 624 to control the amount of fluid that may flow from the inlet 618 to the outlet 614 when the poppet 634 is displaced from its sealed position by the electromagnetic force. This fluid metering valve may function as described above with reference to valve 100, with the flow of fluid proportionally or linearly related to the amount of current applied to the solenoid valve.

Needle 626 and its interface with orifice 624 differ from other embodiments of the technology in its shape and interface with the orifice. For example, needle 626 is arcuate, or has an arcuate surface 627 that interacts with orifice 624. In an embodiment, arcuate surface 627 may be an exponential curve, or may have any curvature as desired to provide a flow area between needle 626 and orifice 624 that will produce the desired flow of fluid.

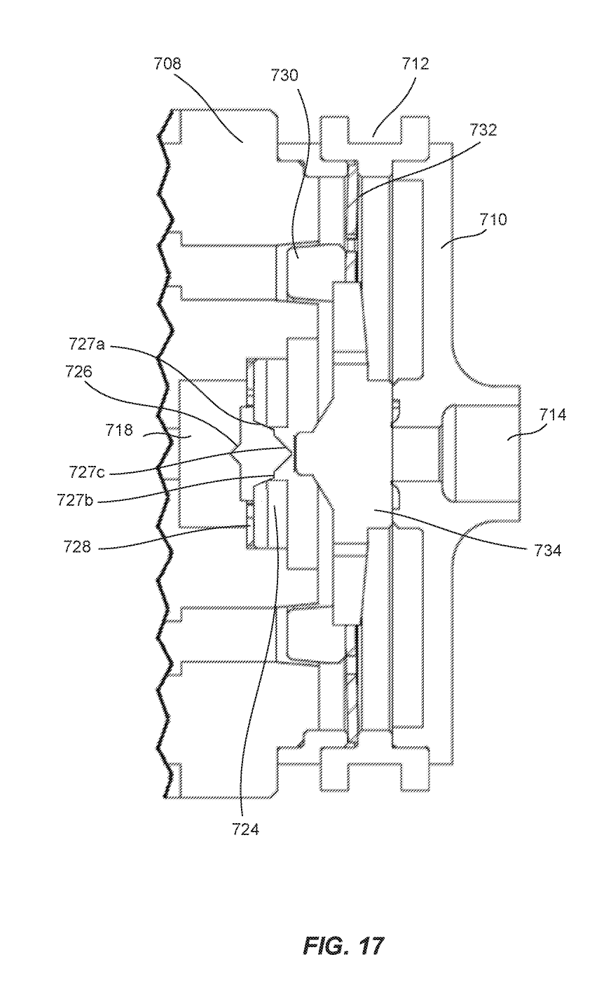

FIG. 17 depicts another example of a portion of a fluid metering valve according to the technology, where like reference numerals represent like components from previous embodiments of the fluid metering valve of the technology. Specifically, as with other embodiments disclosed herein, the valve includes a valve guide 708 and a valve seat 710, with an armature 730 suspended from a first flat spring 732. A poppet 734 is attached to the armature 730. The poppet 734 may be configured and dimensioned to provide a seal limiting the flow of fluid from an inlet 718 to an outlet 714. Furthermore, an orifice 724 is disposed proximal to the inlet 718 and within the flow of fluid from inlet 718 to outlet 714. Orifice 724 may include a shape or geometry that may interact with needle 726 to provide an area through which fluid may flow. For example, orifice 724 may include a chamfer or angled surface 724a. A needle or pin 726 is suspended from a second flat spring 728 such that needle 726 interacts with orifice 624 to control the amount of fluid that may flow from the inlet 718 to the outlet 714 when the poppet 734 is displaced from its sealed position by the electromagnetic force. This fluid metering valve may function as described above with reference to valve 100, with the flow of fluid proportionally or linearly related to the amount of current applied to the solenoid valve.

Needle 726 and its interface with orifice 724 differ from other embodiments of the technology in its shape and interface with the orifice. For example, needle 726 is stepped, or has an arcuate surface with a first angled surface 727a having a first slope, a stepped surface 727b, and a second angled surface 727c having a slope that is either the same or different from the slope of angled surface 727a. Needle 726 may provide for a sudden and immediate increase in flow or burst at a desired current input based on the displacement of the needle, as discussed herein.

In general, the technology provides for an electronic fluid metering valve, which may include an electromagnetic solenoid, a valve body disposed adjacent the electromagnetic solenoid, and an inlet and an outlet, each of the inlet and the outlet formed in either the electromagnetic solenoid or the valve body. The valve further may include a first Archimedes-type spring and a second Archimedes-type spring. The first and second Archimedes-type springs may be disposed in the valve body. The valve may further include an armature suspended by the first Archimedes-type spring and a needle suspended by the second Archimedes-type spring. The needle may be disposed between the inlet and the outlet of the valve body. The needle may further be conical shaped and may be configured and dimensioned to control the flow of fluid from the inlet to the outlet. Additionally, the needle may not be directly coupled to the armature of the valve.

The fluid metering valve may further include a poppet coupled to the armature, a housing disposed adjacent to the valve body, a machined bobbin assembly, or bobbin, disposed in the housing, and a coil disposed around the bobbin. An electromagnetic force may be created when current is applied to the coil of the valve. Furthermore, the needle may be displaced when current is applied to the coil, and the relationship between the amount of current applied to the coil and the displacement of the needle may be linear or proportional.

Similarly, the technology may relate to an electronic fluid metering apparatus, including a proportional solenoid and a valve comprising at least two flat springs. The technology may also relate to a method of metering the flow of fluid. Such method may include the steps of providing an electronic controller, providing a proportional solenoid valve in communication with the electronic controller, providing an external flow meter in communication with the electronic controller, measuring the flow rate of a fluid at the external flow meter, and adjusting a current input from the electronic controller to the proportional solenoid valve in order to adjust the flow rate of the fluid. The flow rate of the fluid may be a function of the input current. In one example of the method of the present invention, the flow rate of the fluid may be directly proportional to the input current. The proportional solenoid valve may further comprise an inlet, and outlet, and a needle disposed between the inlet and the outlet, the needle suspended by a flat spring. In one example of the presently disclosed method, the proportional solenoid valve further comprises an armature disposed within the valve and suspended by two flat springs.

The foregoing detailed description describes the technology with reference to specific exemplary aspects. However, it will be appreciated that various modifications and changes can be made without departing from the scope of the present technology as set forth in the appended claims. The detailed description and accompanying drawings are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the technology, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the technology should be determined solely by the appended claims and their legal equivalents, rather than by the descriptions and examples given above.

1. An electronic fluid metering valve, comprising:
an electromagnetic solenoid;
a valve body disposed adjacent the electromagnetic solenoid;
an inlet and an outlet, each of the inlet and the outlet formed in either the electromagnetic solenoid or the valve body;
an armature disposed within the valve body,
at least a first flat spring disposed between the armature and the valve body;
a needle disposed within the valve body between the inlet and the outlet of the valve body; and,
a second flat spring disposed between the needle and the valve body.

2. The valve of claim 1, wherein the needle is configured and dimensioned to control a flow of fluid from the inlet to the outlet.

3. The valve of claim 2, wherein the needle is shaped to provide a flow of fluid that is proportional to an amount of current applied to the electromagnetic solenoid.

4. The valve of claim 2, wherein the shape of the needle is arcuate, conical, or stepped.

5. The valve of claim 1, wherein the needle is not directly coupled to the armature.

6. The valve of claim 5, wherein a gap is disposed between the needle and the armature when the armature is at a resting or de-energized position.

7. The valve of claim 1, further comprising:
a poppet coupled to the armature and disposed between the needle and the outlet;
a housing disposed adjacent to the valve body;
a bobbin assembly disposed in the housing; and
a coil disposed around the bobbin assembly.

8. The valve of claim 7, wherein an electromagnetic force is created when current is applied to the coil which causes the armature and poppet to displace in an axial direction.

9. The valve of claim 7, wherein the relationship between the amount of current applied to the coil and the axial displacement of the needle is linear.

10. The valve of claim 2, wherein an outer diameter of the electromagnetic solenoid is one inch or smaller and the fluid pressure of the flow of fluid is at least 500 psi.

11. An electronic fluid metering apparatus, comprising:
a coil disposed about a bobbin, the bobbin comprising an angled face;
an armature comprising an angled face aligned with the angled face of the bobbin;
a needle disposed within a valve body between an inlet and an outlet;
at least two flat springs disposed adjacent one or both of the armature and the needle;
wherein the needle is displaced axially when a current is applied to the coil;
wherein the relationship between amount of current applied to the coil and the axial displacement of the needle is linear.

12. The electronic fluid metering apparatus of claim 11, wherein the at least two flat springs comprises three flat springs, wherein a first and third flat spring are disposed between the armature and the valve body and a second flat spring is disposed between the needle is and the valve body.

13. The electronic fluid metering apparatus of claim 11, further comprising an electronic controller to meter the current applied to the solenoid.

14. The electronic fluid metering apparatus of claim 11, further comprising an orifice disposed between the needle and the outlet.

15. The electronic fluid metering apparatus of claim 14, wherein the needle and orifice allow fluid to flow toward the outlet when no current is applied to the coil, and wherein the armature limits the flow of fluid to the outlet.

16. The electronic fluid metering apparatus of claim 15, wherein when the solenoid is energized, the armature is displaced from the outlet to no longer limit the flow of fluid to the outlet and the armature does not contact the needle.

17. A method of metering the flow of fluid, comprising:
providing an electronic controller;
providing a proportional solenoid valve in communication with the electronic controller, the valve comprising at least two flat springs;
providing an external flow meter in communication with the electronic controller;
measuring the flow rate of a fluid at the external flow meter;
adjusting a current input from the electronic controller to the proportional solenoid valve in order to adjust the flow rate of the fluid.

18. The method of claim 17, wherein the flow rate of the fluid is directly proportional to the input current.

19. The method of claim 17, wherein the proportional solenoid valve comprises an inlet, and outlet, and a needle disposed between the inlet and the outlet, and wherein a flat spring is disposed between the needle and a valve body of the solenoid valve.

20. The method of claim 19, wherein the proportional solenoid valve further comprises an armature disposed within the valve and at least one flat spring disposed between the armature and the valve body.
